(19) United States
(12) Patent Application Publication
(10) Pub. No.: US 2005/0108121 A1
(43) Pub. Date: May 19, 2005

(54) Open loop stored value system

(75) Inventors: Amber Gravett, Omaha, NE (US); Todd R. Nuzum, Omaha, NE (US); Richard F. Klein, Colorado Springs, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/714,437

(22) Filed: Nov. 14, 2003

(51) Int. Cl. G06F 17/60

(52) U.S. Cl. 705/35

(57) ABSTRACT

According to the invention, a payment system for open loop stored benefit products is disclosed. The payment system includes a web-accessible platform, a web interface, a credit processing system, and a translation system. The web-accessible platform is available to a payor for purchase of a stored value account for use by a payee. The web-accessible platform communicates with a first application interface. The stored benefit account is backed by an account issuer and is accepted by a network of unrelated merchants who accept payments from the account issuer. The web interface allows the payor and/or the payee to interact with the web-accessible platform. The credit processing system communicates with a second application interface. The translation system translates between the first application interface and the second application interface.

This application is related to U.S. patent application Ser. No. 10/159,784, filed on May 31, 2002, entitled “Stored Value Education Account”; U.S. patent application Ser. No. 09/955,747, filed on Sep. 18, 2001, entitled “Method & System for Transferring Stored Value”; U.S. patent application Ser. No. 10/696,014, filed on Oct. 28, 2003, entitled “System for Activation of Multiple Cards”; U.S. patent application Ser. No. 10/405,043, filed on Mar. 31, 2003, entitled “Methods and Systems for Processing Unrestricted Stored-Value Instruments”; U.S. Provisional Patent Application Ser. No. 60/515,918, filed on Oct. 29, 2003, entitled “Health Care Eligibility Verification Systems and Methods”; U.S. patent application Ser. No. 10/675,929 filed on Sep. 29, 2003, entitled “Systems & Methods for Verifying Medical Insurance Coverage”; U.S. patent application Ser. No. 10/694,925, filed on Oct. 27, 2003, entitled “Methods and Systems for Processing Transactions for Integrated Credit and Stored-Value Programs”; U.S. patent application Ser. No. 10/694,924, filed on Oct. 27, 2003, entitled “Methods and Systems for Managing Integrated Credit and Stored-Value Programs”; U.S. patent application Ser. No. 10/079,927, filed on Feb. 19, 2002, entitled “Systems & Methods for Operating Loyalty Programs”; U.S. patent application Ser. No. 10/421,604, filed on Apr. 22, 2003, entitled “Multi-Purse Card System and Methods”; U.S. patent application Ser. No. 10/690,394, filed on Oct. 20, 2003, entitled “Systems and Methods for Fraud Management in Relation to Stored Value Cards”; U.S. Patent Application filed concurrently herewith, entitled “Open Loop Stored Value Account Configuration” (temporarily referenced by Attorney Docket No. 020375-047700US); U.S. Provisional Patent Application filed concurrently herewith, entitled “Bulk Card Ordering System and Methods” (temporarily referenced by Attorney Docket No. 020375-043000US); U.S. Provisional Patent Application filed concurrently herewith, entitled “Stored Value Lottery Card and Methods” (temporarily referenced by Attorney Docket No. 020375-044500US), U.S. Provisional Patent Application filed concurrently herewith, entitled “System for Accounting” (temporarily referenced by Attorney Docket No. 020375-018810US), which are incorporated by reference in their entirety.

### BACKGROUND OF THE INVENTION

This invention relates in general to financial transaction processing and, more specifically, to stored value accounts usable in an open loop system.

Closed loop stored value cards are becoming popular. These cards have a balance associated with them that can be drawn upon for purchases with a small group of participating merchants. Stored value cards are available for purchase a retail locations, but have limited functionality. Traditional credit cards are preferred by many for their versatility.

Branded credit card associations allow an issuing bank to offer credit cards to consumers and merchant accounts to businesses. Examples of branded credit card associations include VISA,™ MASTERCARD,™ AMERICAN EXPRESS,™ DINERS CLUB,™ DISCOVER CARD,™ etc. Issuing banks are members of the branded credit card associations and agree to honor payment transfers from other issuing banks. In this way a consumer can use their credit card with any business with a merchant account even if the consumer is associated with a different issuing bank than the issuing bank of the business.

There are credit card processing host systems that allow card issuing banks to open and maintain credit card accounts for consumers. These credit card processing host systems sometimes have web front ends such that a consumer can open accounts and view transaction histories. Credit card processing host systems communicate with other systems by an application interface. On such application interface for a credit card processing system uses Open Data Stream (ODS) as a protocol for creating accounts and accessing account information.

### BRIEF DESCRIPTION OF THE DRAWINGS

The present invention is described in conjunction with the appended figures:

FIG. 1A is a block diagram of an embodiment of a payment system;

FIG. 1B is a block diagram of another embodiment of the payment system;

FIG. 1C is a block diagram of yet another embodiment of the payment system;

FIG. 1D is a block diagram of still another embodiment of the payment system;

FIG. 2 is a block diagram of an embodiment of a web server;

FIG. 3 is a block diagram of an embodiment of a credit processing host system;

FIG. 4 is a flow diagram of an embodiment of a process for creating a stored value account; and

FIG. 5 is a flow diagram of an embodiment of a process for maintaining the stored value account.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

In one embodiment, the present invention provides a payment system for open loop stored benefit products. The payment system includes a web-accessible platform, a web interface, a credit processing system, and a translation system. The web-accessible platform is available to a payor for purchase of a stored value account for use by a payee. The web-accessible platform communicates with a first application interface. The stored benefit account is backed by an account issuer and is accepted by a network of unrelated merchants who accept payments from the account issuer. The web interface allows the payor and/or the payee to interact with the web-accessible platform. The credit processing system communicates with a second application interface. The translation system translates between the first application interface and the second application interface.

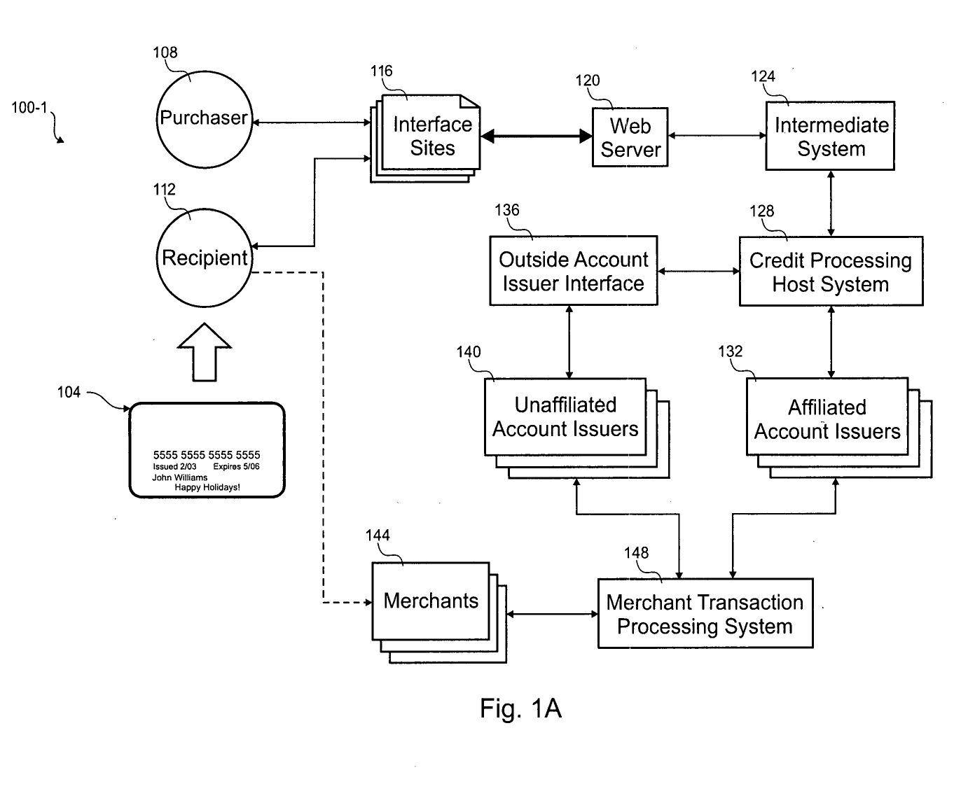

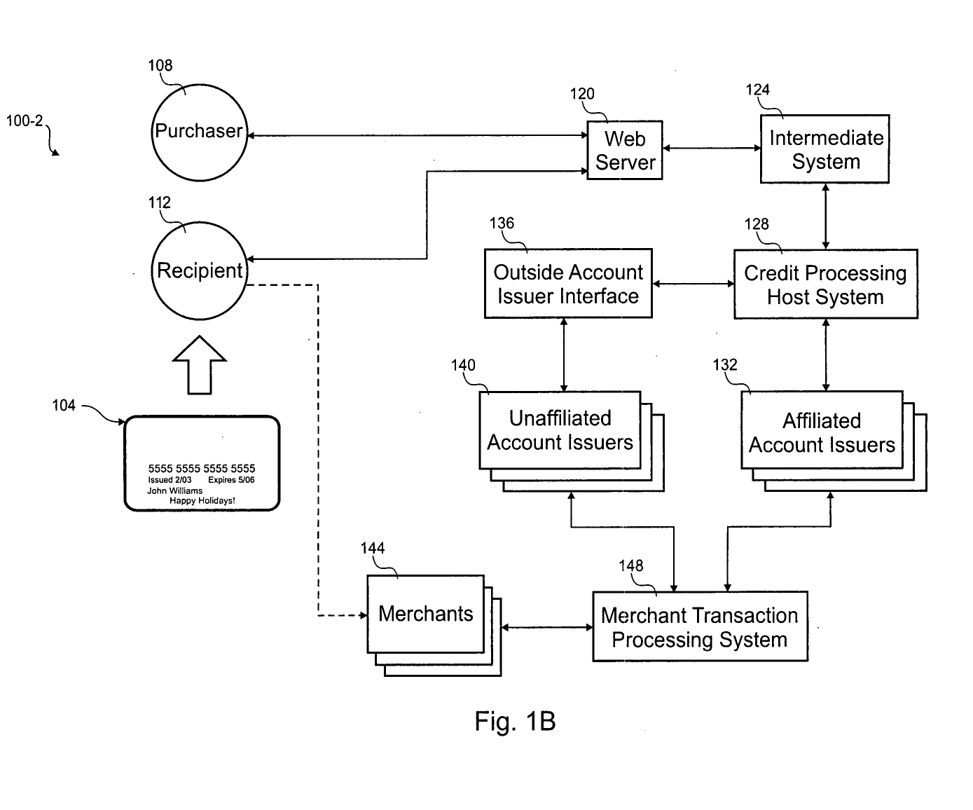

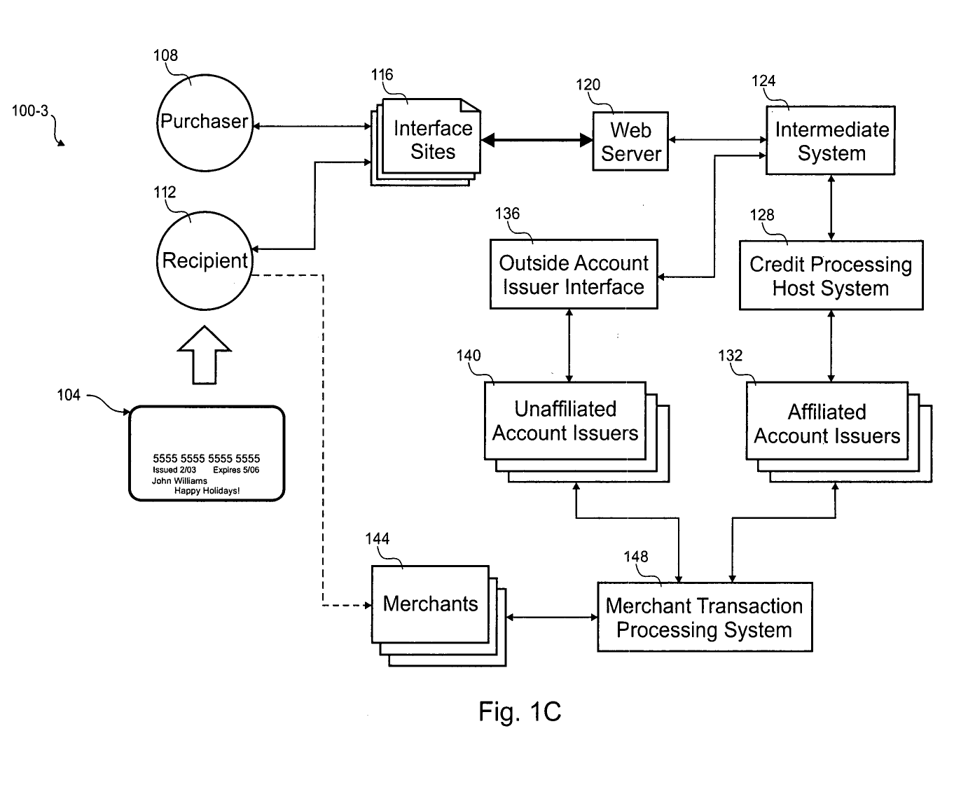

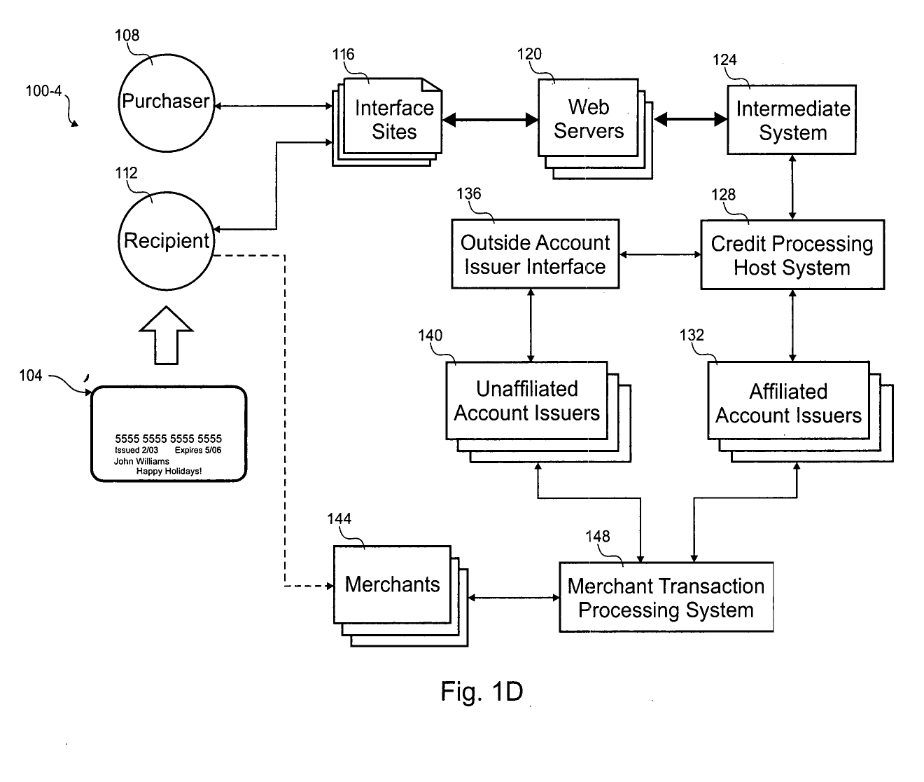

Referring first to FIG. 1A, a block diagram of an embodiment of a payment system 100-1 is shown. In this embodiment, a purchaser 108 buys a stored value card 104 for a recipient 112. The stored value card 104 looks similar to a credit card with a card number, the recipient's name, an expiration date, and an optional greeting. The purchaser 108 enters the recipient name and optionally can customize the greeting. Other embodiments avoid use of a card by using any type of carrier for the account information, for example, a paper card, an optical card, a smart card, a token, an RFID tag, a cell phone, a PDA, or biometric authentication. Further still, some embodiments use an online system as the carrier of the account information such that the recipient is never issued a tangible carrier such as is described in U.S. patent application Ser. No. 10/159,784 or U.S. patent application Ser. No. 09/955,747, previously incorporated by reference.

The stored value card 104 in this embodiment is a gift card usable in an open loop manner, that is to say, the gift card is usable at any merchant 144 accepting payment from a particular branded credit card association (VISA,™ MASTERCARD,™ AMERICAN EXPRESS,™ DINERS CLUB,™ DISCOVER CARD,™ etc.). The invention is not to be limited to credit card associations, but could be any debit, credit, or complementary currency association that has many unrelated merchants who accept the stored value card 104. The stored value card 104 could be used for any application where complementary currency, benefits or money are loaded into a stored value card, for example, a health care card with benefit tables, a VISA BUXX™ card loaded by a parent or other purchaser 108, a payroll card loaded by the employer 108, a hybrid credit and stored value card, etc.

The purchaser 108 interacts with an interface site 116 to order the stored value card 104. In this embodiment, there are many interface sites 116, but the purchaser 108 would select one. The interface site 116 explains the various stored value products and has order forms. The forms allow selecting a card style, personalizing the greeting, entering recipient information, entering the purchaser's payment information, etc. Information from the interface site 116 is securely passed to the web server 120 using HTML and/or XML formats. The web server 120 can host interface sites 116 and/or communicate with non-hosted interface sites 116.

An intermediate system 124 interfaces the web server 120 to a credit processing host system (CPHS) 128. A first application interface is used between the web server 120 and the intermediate system 124 and a second application interface is used between the intermediate system 124 and the CPHS 128. The intermediate system 124 translates between the two application interfaces. The first application interface uses an XML format and the second application interface uses Open Data Stream (ODS) format. The intermediate system 124 uses an ECS™ hardware platform with PEGA SYSTEMS™ and EVOLVE™ software. Some embodiments could embed the functionality of the intermediate system 124 in either the web server 120, the CPHS 128 or partially in both.

The CPHS 128 is a main frame system in this embodiment that uses a main frame language such as EBSIDEC, but other mainframe languages could be used. The various account issuers in the branded credit card association variously used by the merchants, the purchaser 108 and the stored value card 104 are accessible to the CPHS for clearing payments, creating accounts, loading stored value, authorizing transactions, gathering transaction information, etc. The CPHS 128 is directly coupled to certain affiliated account issuers 132, such as an issuing bank, and indirectly coupled to unaffiliated account issuers 140. An outside account issuer interface 136 is used to communicate with the unaffiliated account issuers 140. Although in this embodiment the CPHS 128 is a credit platform, in some embodiments a debit and/or credit platform could be used instead.

The recipient 112 can use the stored value card 104 at any merchant 144. The various merchants 144 clear payments through the account issuers 132, 140 by way of a merchant transaction processing system 148. By interacting with the interface site 116, the recipient 112 can configure a login for the stored value account, change their address, request a replacement card, reload the card 104 in some products, view transaction information, request a check payout, and/or report stolen or otherwise cancel the card 104, etc. Similarly, but dependent on the stored value product, the purchaser 108 can login to reload the card 104, view transaction information, and/or cancel or report stolen the card 104, etc.

With reference to FIG. 1B, a block diagram of another embodiment of the payment system 100-2 is shown. In this embodiment, the interface sites 116 are hosted integrally with the web server 120. Some embodiments could host some interface sites 116 while supporting other interface sites 116 that are not hosted.

Referring to FIG. 1C, a block diagram of yet another embodiment of the payment system 100-3 is shown. In this embodiment, the intermediate system 124 communicates with the outside account issuer interface 136 for unaffiliated account issuers 140 rather than using the CPHS 128 for this purpose. AUTHORIZE NET™ is one example of an outside account issuer interface 136 that could be used in this embodiment. Some embodiments of the intermediate system 124 could interface with a number of outside account issuer interfaces 136. There are many variations on the possible topology to allow stored value accounts on the various branded credit card association systems.

With reference to FIG. 1D, a block diagram of still another embodiment of the payment system 100-4 is shown. In this embodiment, there are a number of web servers 120. Each web server 120 could host or not some interface sites 116. All the web servers 120 would connect to the intermediate system 124.

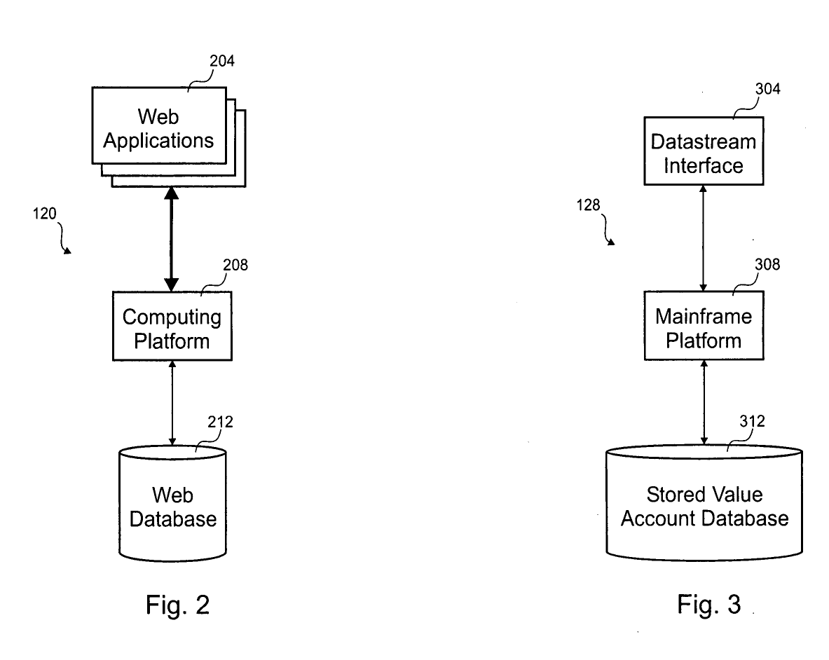

Referring next to FIG. 2, a block diagram of an embodiment of the web server 120 is shown. In this embodiment, the web applications 204 operate in a WEBSPHERE™ J2EE™ application environment. The web applications 204 could include interface sites 116, software to process calls with interface sites 116, software to communicate with the intermediate system 124, software to interface with a web database 212, etc. The computing platform in this embodiment uses a APACHE™ server environment.

The web database 212 stores certain information for configuring and maintaining stored value accounts. Information such as the purchaser login, recipient login, recipient name, previous stored value card order information, information to retrieve the purchaser's payment information from the CPHS 128, delivery address for the stored value card 104, etc. are stored in the web database. Confidential account information that could be used by hackers for use to fraudulently deplete a stored value card 104 is not stored in the web database for this embodiment. A hacker who accessed the web database 212 could not gather enough account information to make purchases with the issued stored value cards 104. Other embodiments could store this information in the web database 212 should the security of the web server 120 warrant that level of trust.

With reference to FIG. 3, a block diagram of an embodiment of CPHS 128 is shown. A datastream interface 304 receives and interprets the ODS formatted transactions received from the intermediate system 124. A mainframe platform is a legacy system that is used to process credit card type transactions. Confidential card information is stored on a stored value account database (SVAD) 312. The SVAD holds the purchaser's payment information, the stored value card information, transaction histories, and other information related to use of the stored value card 104. Other credit card processing information could also be stored in the SVAD 312.

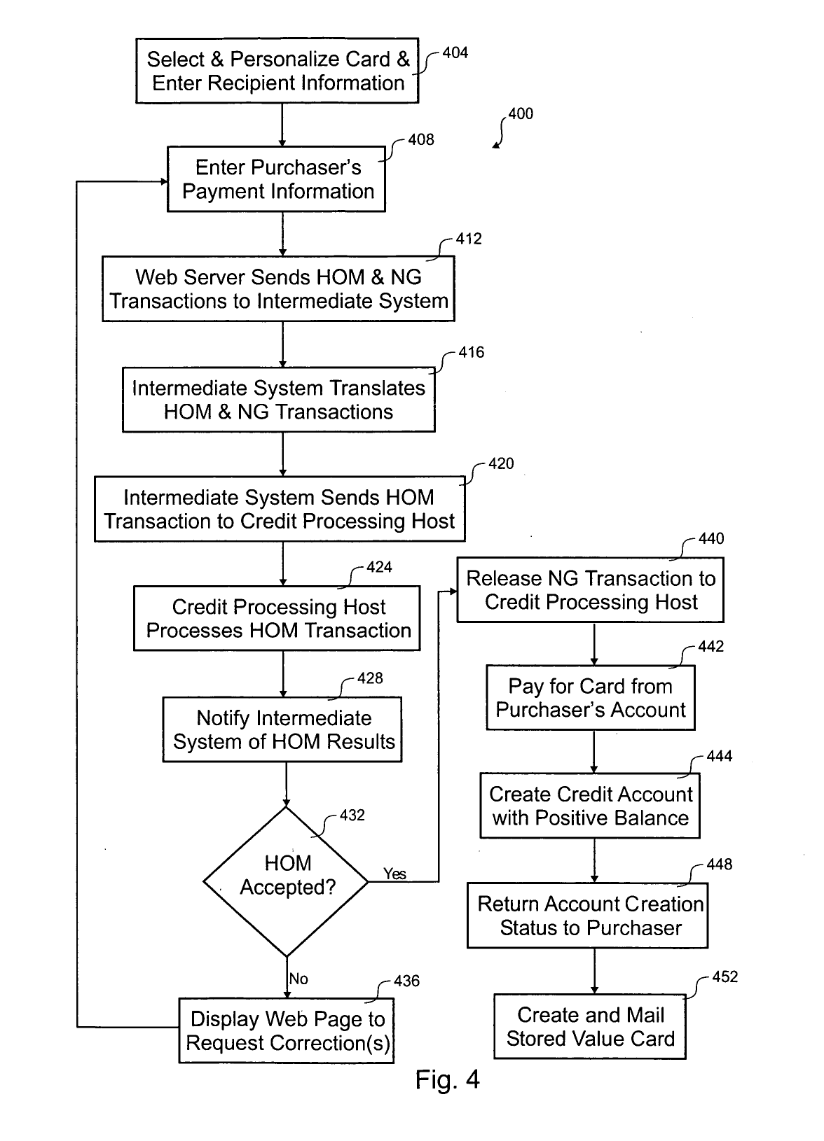

Referring next to FIG. 4, a flow diagram of an embodiment of a process 400 for creating a stored value account is shown. This embodiment creates a gift card 104. The depicted portion of the process 400 begins in step 404 where the purchaser 108 selects a card design, enters a personal message, selects a stored value amount, enters a recipient name, enters a recipient phone number, enters a recipient phone number, and/or selects an optional e-mail announcement that can be personalized, etc. In step 408, the purchaser 108 enters information to pay for the stored value card 104. Funding sources could include a credit card, a debit card, an electronic check, complementary currency, a stored value card 104, and/or a stored value account (e.g., MONEYZAP,™ C2IT™ or PAYPAL™), etc. The information gathered in steps 404 and 408 are forwarded from the interface site 116 to the web server 120.

In step 412, the web server 120 formulates HOM and NG transaction messages, and perhaps other transaction messages, from the information gathered at the interface site 116. The HOM and NG transaction messages are sent to the intermediate system 124. Generally, the HOM transaction message queries the CPHS 128 for account details the can be used to verify the payment information entered by the purchaser 108, and the NG transaction message is used pay for and create the stored value card 104. At some point, the intermediate system 124 translates the HOM and NG transaction messages into a format compatible with ODS in step 416. The intermediate system 124 in step 420 sends the HOM transaction message to the CPHS 128 for processing in step 424.

The intermediate system 428 is notified of the HOM results in step 428. The intermediate system and/or web server 120 check the HOM results against the entered purchaser's payment information in step 432 to determine if the payment information was entered correctly. Other fraud detection, credit scoring and credit limit checks could be performed with the HOM results, for example the fraud detection of U.S. patent application Ser. No. 10/690,394 (previously incorporated by reference) could be used. Where there is a problem with the purchaser's payment information processing is shunted to step 436 where the interface site 116 displays a web page to request correction of the payment information by looping back to step 408.

If the HOM is accepted by the intermediate system 124 and/or web server 120 in step 432, processing continues to step 440 where the NG transaction message is released to the CPHS 128. The purchaser's payment information is used to transfer money to pay for the stored value amount and any associated fees in step 442. In step 444, a credit card account with a positive balance is created to implement the stored value card 104. The intermediate system 124 and web server 120 are notified of the successful creation of the stored value account such that the interface site 116 can notify the purchaser in step 448. If requested by the purchaser 108, an e-mail message can be also sent to the recipient 112 with notification. In step 452, the stored value card 104 is fabricated and mailed to the address provided by the purchaser 108.

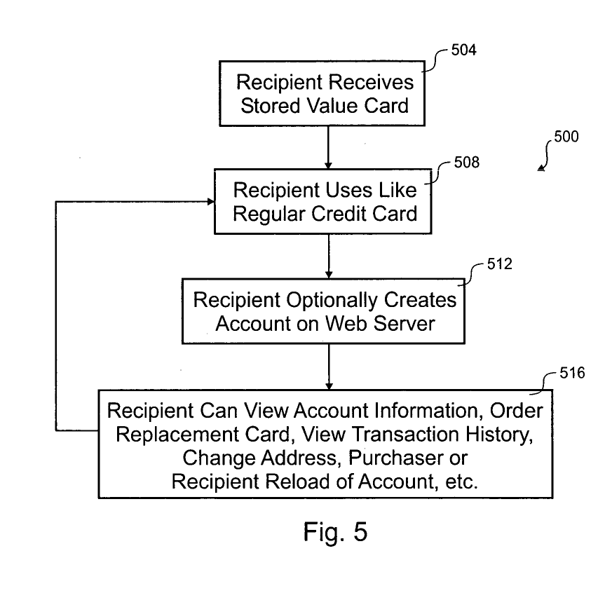

With reference to FIG. 5, a flow diagram of an embodiment of a process 500 for maintaining the stored value account is shown. The depicted portion of the process 500 begins in step 504 where the recipient 112 receives the stored value card 104. At any point, the recipient 112 can use the stored value card 104 in the same manner as a conventional credit card in step 508, for example, split tendering can be used. The stored value card gets all the benefit of the CPHS 128 such as transaction history tracking, decisioning on expenditures, fraud detection through purchase patterning and authorization decisioning. At any point, the recipient 112 can optionally create an account with the web server 120 by entering login information in step 512.

The recipient 112 and/or purchaser 108 can interact in various ways with the interface site 116. Account information can be viewed, a replacement card can be ordered, the purchaser 108 and/or recipient 112 address can be changed, transactions on the stored value card 104 can be viewed, and/or the purchaser 108 and/or recipient 112 can reload the card 104 in step 516. It is noted that steps 508, 512 and 516 can be performed in any order even though depicted serially.

The HOM transaction is a request for the Account Summary XML document. It has a TRANTYPE of HOM. The HOM transaction message is a “view” transaction, rather than a workflow transaction. This is an HOM Request URL that could be issued by the interface site 116: xxxxxxxx.com/fdr.xml?ACCT=1111111111111111&TRANTYPE=HOM. The parameters in the HOM Request URL are specified in TABLE I.

TABLE I

| Name | Value |
|---|---|
| ACCT | Description: Account identifier |
| | Length: variable length, 16 positions |
| | Value type or edits: numeric |
| | This is a required name/value pair. |
| TRANTYPE | Description: Code representing the transaction type |
| | Valid code: |
| | HOM - Account Summary |
| | This is a required name/value pair. |

The below XML datastructure is what the CPHS 128 would return in response to an HOM query.

```
<?xml version=“1.0”?>
-<ACCOUNTSUMMARY>
  <INFO version=“1.2”>First Data Evolve.XML Transactions. </INFO>
  <ACCTID>1111111111111111</ACCTID>
  <SVCSTATUS>ACTIVE</SVCSTATUS>
  <PRIMARYNAME>CLAY, VISTA</PRIMARYNAME>
  <SECONDARYNAME/>
  <ADDRESS1>417 W VISTA CT</ADDRESS1>
  <ADDRESS2/>
  <CITY>MOBILE</CITY>
  <STATE>AL</STATE>
  <POSTALCODE>36609-6121</POSTALCODE>
  <HOMEPHONE>2516662443</HOMEPHONE>
  <WORKPHONE>2516662443</WORKPHONE>
  <BALAMT>91.37</BALAMT>
  <AVAILCREDIT>2208</AVAILCREDIT>
  <CREDITLIMIT>2300</CREDITLIMIT>
  <LASTPAY>20.0</LASTPAY>
  <LASTPAYDATE>030723</LASTPAYDATE>
  <MINPMTDUE>20.0</MINPMTDUE>
  <DTPMTDUE>0829</DTPMTDUE>
  <LASTSTMTBAL>91.36</LASTSTMTBAL>
  <LASTSTMTDATE>030804</LASTSTMTDATE>
  <SSN>423742373</SSN>
  <MOMNAME>TUCKER</MOMNAME>
  <DOB>19511201</DOB>
  <EXTSTATUS />
  <INTSTATUS>D</INTSTATUS>
  <AFFINITY>97975230</AFFINITY>
  <PRIN>0000</PRIN>
  <ANNCASHRT>15.240</ANNCASHRT>
  <ANNMERCHRT>15.240</ANMERCHRT>
  <EXPDATE>1103</EXPDATE>
  <CVC2NO>456</CVC2NO>
  <CVC2NO2 />
  <CVC2NO3 />
  <CHKNUM>12356</CHKNUM>
  <SAVNUM />
  <XREF />
  <AUTOPAYFG>0</AUTOPAYFG>
  <AUTOPAYAMT>0.0</AUTOPAYAMT>
  <ACHAMT>0.0</ACHAMT>
  <TRANRTNUM>107002448</TRANRTNUM>
  <ADNNAME />
</ACCOUNTSUMMARY>
```

The below TABLE II explains the tags and content in the XML datastructure returned in response to the HOM transaction message.

TABLE II

| Return Tags | Return Content |
|---|---|
| ACCOUNTSUMMARY | Wrapper for Account Summary content, which may |
| | include the elements INFO, ACCTID, SVCSTATUS, |
| | PRIMARYNAME, SECONDARYNAME, ADDRESS1, |
| | ADDRESS2, CITY, STATE, POSTALCODE, |
| | HOMEPHONE, WORKPHONE, BALAMT, |
| | AVAILCREDIT, CREDITLIMIT, LASTPAY, |
| | LASTPAYDATE, MINPMTDUE, DTPMTDUE, |
| | LASTSTMTBAL, LASTSTMTDATE, SSN, MOMNAME, |
| | DOB, EXTSTATUS, INTSTATUS, AFFINITY, |
| | PRIN, ANNCASHRT, ANNMERCHRT, EXPDATE, |
| | CVC2NO, CVC2N02, CVC2NO3, ADNNAME, |
| | CHKNUM, SAVNUM, XREF, AUTOPAYFG, |
| | AUTOPAYAMT, ACHAMT, TRANRTNUM, ERROR |
| INFO | Name of the application that generated this XML |
| | document (e.g., First Data Evolve, XML Transactions, |
| | Version 1.2) |
| ACCTID | Account identifier |
| SVCSTATUS | Code representing whether the plastic is activated |
| | Valid codes: |
| | ACTIVE - activated |
| | AVAIL - not activated |
| PRIMARYNAME | Principal customer's name |
| SECONDARYNAME | Secondary customer's name |
| ADDRESS1 | First line of the principal customer's address |
| ADDRESS2 | Second line of the principal customer's address |
| CITY | City of the principal customer's address |
| STATE | State of the principal customer's address |
| POSTALCODE | ZIP code of the principal customer's address |
| HOMEPHONE | Principal customer's home telephone number |
| WORKPHONE | Principal customer's work telephone number |
| BALAMT | Current balance (represented as dollars and cents) |
| AVAILCREDIT | Current available credit (represented as whole dollars) |
| CREDITLIMIT | Account's credit limit (represented as whole dollars) |
| LASTPAY | Last payment amount posted (represented as whole |
| | dollars) |
| LASTPAYDATE | Date the last payment posted to the account (YYMMDD) |
| MINPMTDUE | Minimum payment due (fixed) as shown on the |
| | customer statement (represented as dollars and cents) |
| DTPMTDUE | Date minimum payment is due as shown on the |
| | customer statement (MMDD) |
| LASTSTMTBAL | Last statement balance |
| LASTSTMTDATE | Last statement date (YYMMDD) |
| SSN | Social Security number of principal customer |
| MOMNAME | Principal customer's mother's maiden name |
| DOB | Principal customer's date of birth |
| EXTSTATUS | External status of account |
| INTSTATUS | Internal status of account |
| AFFINITY | Customer's employee ID number |
| PRIN | Principal Bank Identifier |
| ANNCASHRT | Annual cash rate (finance charge) |
| ANNMERCHRT | Annual merchandise rate (finance charge) |
| EXPDATE | Plastic expiration date |
| CVC2NO | Card Verification Value (CVV) for Visa Plastics/Card |
| | Validation Code (CVC) for Mastercard Plastics when the |
| | expiration date |
| CVC2N02 | Card Verification Value (CVV) for Visa Plastics/Card |
| | Validation Code (CVC) for Mastercard Plastics when the |
| | expiration date is the reissue expiration date |
| CVC2NO3 | Card Verification Value (CVV) for Visa Plastics/Card |
| | Validation Code (CVC) for Mastercard Plastics when the |
| | expiration date is the adjustment expiration date |
| CHKNUM | Demand deposit account number or customer checking |
| | account number on the cardholder account record |
| SAVNUM | Savings account number on the cardholder account |
| | record |
| XREF | Identifier of cross-reference account |
| AUTOPAYFG | Automatic payment flag - code indicating whether to |
| | generate an automatic payment charge using the |
| | customer's checking or savings account number |
| AUTOPAYAMT | Automatic payment amount - amount the customer |
| | agreed to pay via the automatic payment option |
| ACHAMT | ACH amount - amount of the previous demand ACH |
| | payment (amount a customer has authorized as a |
| | payment to send in through the Automated |
| | Clearinghouse) |
| TRANRTNUM | Transit routing number on the cardholder account |
| | record |
| ADNNAME | Wrapper for additional name(s) - dependents of |
| | customer). Contains ENTRY tag for each name |
| ENTRY | Dependent's information. |
| ERROR | Error message |

Gift card transactions are COMMIT type and contain the REQTYPE GTCD. Gift card transactions are further defined by their GTCDPATH. The gift card transaction with a GTCDPATH of NORMAL2 is a transaction to allow an institution that sells gift cards 104 with an interface site 116 to submit a request to build a gift card and load it from an account that may or may not be affiliated with the CPHS 128. Furthermore, the account used to purchase the gift card 104 may or may not belong to the gift card vendor of the interface site 116. This embodiment of the NG transaction message allows up to three adjustments.

The NG transaction message appears in the following format, although this example does not contain all possible parameters. This URL would be sent by the web server 120 to the intermediate system 124.
xxxxxxxx.comlfdr.xml?DN=AAAA0000&TRANTYPE=COMMIT&REQTYPE=GTCD&GTCD PATH=NORMAL2&ACCT=1111111111111111&TOTAMTARR0=2500&DESCARR0=SPECIAL&BATCHMERCH0=A&TOTAMTARR1=3500&DESCARR1=SPECIAL2&BATCHMER CH1=B&AUTHAMT=7500&PNAME=SMITH,JOHN&ADDR1=445 PINE STREET&ADDR 2=APT 2&CITY=OMAHA&STATE=NE&ZIP=33333&HMPHN=0000000000&WKPHN=0 000000000&PLASTYPE=1&CARDMESS=Good job!&CRDAMT00=2500&NGEXPDATE=0505&NGSYS=3333&NGPRIN=3333&NGAGT=3333&MISC3=HELLO&MISC4=GOODBYE&RUSHCODE=BA&MMN=TOBIN&INFOFG=Y&ONLINEFG=Y&PRODFG=Y&FIN4FG=Y&LOGOFG=Y&NGMEMFG=Y&CRSREFFG=Y&SHPADRFG=Y&UPC8FG=Y&UPC2FG=Y&UPC3FG=Y&RSTATEFG=Y&PAPOFFFG=Y&HEARD=5&STFORM=MGD&FORMAT=021&DISCL=AB&PRODTYPE=345&FIN4=GC01&LOGOCD=00050&GTCDHSTMEM=!&PURNAME=JOE,SMITH&PURADDR=FAKE ST&SHPADR=0&UPCCD8=511&UPCCD2=L&UPCC D3=A&STCD=04&TRACKID=12345

TABLE III that follows provides a key to the possible parameters in the above URL.

TABLE III

| Parameter | Description |
|---|---|
| DN | Financial institution's “quad number” |
| ACCT | Account identifier of the account purchasing the gift card |
| | Length: variable length, 16 positions |
| | Edits: edited for numeric values |
| | This is a required parameter. |
| TRANTYPE | Code representing the transaction type |
| | Valid code: |
| | COMMIT - COMMIT type transaction |
| | This is a required parameter. |
| REQTYPE | Code representing the request type |
| | Valid code: |
| | GTCD - Gift card request |
| | This is a required parameter. |
| GTCDPATH | Code representing the gift card path |
| | Valid code: |
| | NORMAL2 - Gift card transaction to build and load a gift |
| | card |
| | This is a required parameter. |
| AUTHAMT | Total amount of the authorization request |
| | Format: dollar and cent ($$$$$¢¢) |
| | Length: variable length, 13 positions |
| | Edits: edited for numeric values |
| | This is a required parameter. |
| TOTAMTARR0 | Total amount of first item being adjusted; cents must be |
| | submitted as zeros |
| | Format: dollar and cent ($$$$$¢¢) |
| | Length: variable length, 13 positions |
| | Edits: edited for numeric values |
| | This is a required parameter. |
| TOTAMTARR1 | Total amount of second item being adjusted; cents must be |
| | submitted as zeros |
| | Format: dollar and cent ($$$$$¢¢) |
| | Length: variable length, 13 positions |
| | Edits: edited for numeric values |
| | This is an optional parameter. |
| TOTAMTARR2 | Total amount of third item being adjusted; cents must be |
| | submitted as zeros |
| | Format: dollar and cent ($$$$$¢¢) |
| | Length: variable length, 13 positions |
| | Edits: edited for numeric values |
| | This is an optional parameter. |
| DESCARR0 | Client-defined text describing the first adjustment detail |
| | item |
| | Length: variable length, 37 positions |
| | Edits: none |
| | This is a required parameter. |
| DESCARR1 | Client-defined text describing the second adjustment detail |
| | item |
| | Length: variable length, 37 positions |
| | Edits: none |
| | This parameter is required only if you are also sending |
| | TOTAMTARR1. |
| DESCARR2 | Client-defined text describing the third adjustment detail |
| | item |
| | Length: variable length, 37 positions |
| | Edits: none |
| | This parameter is required only if you are also sending |
| | TOTAMTARR2. |
| BATCHMERCH0 | Code representing batch and merchant to use for this |
| | adjustment |
| | Valid codes: |
| | A - Client defined |
| | B - Client defined |
| | C - Client defined |
| | This is a required parameter. |
| BATCHMERCH1 | Code representing batch and merchant to use for this |
| | adjustment |
| | Valid codes: |
| | A - Client defined |
| | B - Client defined |
| | C - Client defined |
| | This parameter is required only if you are also sending |
| | TOTAMTARR1. |
| BATCHMERCH2 | Code representing batch and merchant to use for this |
| | adjustment |
| | Valid codes: |
| | A - Client defined |
| | B - Client defined |
| | C - Client defined |
| | This parameter is required only if you are also sending |
| | TOTAMTARR2. |
| PNAME | Name of the gift card recipient in one of these formats |
| | (refer to Cardholder New Accounts for more information |
| | about name entry) |
| | (JONES, JOHN N) |
| | (JOHNSON-JONES, MARY M) |
| | (JONES, JOHN N/DR) |
| | (JONES MD, JOHN N) |
| | Length: variable length, 26 positions |
| | Edits: edited for alpha values and comma |
| | This is a required parameter. |
| | The number of positions you enter depends on the |
| | embossing format you use. For MasterCard or dual Visa |
| | accounts, only 24 characters may be used for the primary |
| | name. The last two positions, 25 and 26, must be space |
| | filled. |
| ADDR1 | Text of the first line of the address to which the gift card is |
| | to be mailed |
| | Length: variable length, 26 positions |
| | This is a required parameter. |
| ADDR2 | Text of the second line of the address to which the gift card |
| | is to be mailed |
| | Length: variable length, 26 positions |
| | This is an optional parameter. |
| | Enter the city name in this field if the gift card recipient |
| | has a non-U.S. address. |
| CITY | City of the address to which the gift card is to be mailed |
| | Length: variable length, 18 positions |
| | This is a required parameter. |
| | Enter the country name in this field if the gift card |
| | recipient has a non-U.S. address. |
| STATE | State of the address to which the gift card is to be mailed |
| | Length: fixed length, two positions |
| | Refer to the Reference Manual for list of valid state codes. |
| | This is a required parameter. |
| ZIP | ZIP code or postal code in the address to which the gift card |
| | is to be mailed |
| | Length: five or nine positions |
| | Edits: edited for numeric values |
| | This is a required parameter. |
| | Enter 00000 for countries other than the United States |
| HMPHN | Home area code and telephone number of the gift card |
| | recipient |
| | Length: fixed length, 10 positions |
| | Edits: edited for numeric values |
| | This is an optional parameter. |
| WKPHN | Business area code and telephone number of the gift card |
| | recipient |
| | Length: fixed length, 10 positions |
| | Edits: edited for numeric values |
| | This is an optional parameter. |
| PLASTYPE | Code representing a client-defined plastic type. Each |
| | system/principal/agent combination can have up to 5. |
| | Valid codes: |
| | 1 - Client defined |
| | 2 - Client defined |
| | 3 - Client defined |
| | 4 - Client defined |
| | 5 - Client defined |
| | This is a required parameter. |
| CARDMESS | Free-form text to be embossed on the gift card |
| | Length: variable length, 26 positions |
| | Edits: edited for valid embossing characters |
| | This is an optional parameter. |
| CRDAMT00 | Amount of the gift card (does not include fee or |
| | express delivery charge); cents must be submitted |
| | as zeros |
| | Note: The following information applies only if you |
| | are not using NM*177 to populate miscellaneous |
| | field 10 (this is controlled with the INFOFG |
| | parameter). Refer to the CRDAMTOO information |
| | that follows the INFOFG parameter listing if you |
| | are using NM*177. |
| | Format: $$$¢¢ |
| | Length: variable length, 13 positions |
| | Edits: edited for numeric values |
| | This is a required parameter. |
| NGEXPDATE | Date the gift card expires |
| | Format: MMYY |
| | Length: fixed length, four positions |
| | Edits: edited for a valid numeric month and year |
| | equal to or greater than the current date. You also |
| | can enter spaces, zeros, or nines in this field. |
| | If you leave this field blank or enter zeros, the |
| | System uses the customer expiration months |
| | parameters in the Reissue Period section (RE OP |
| | RP) of the Product Control File to determine the |
| | expiration date. |
| | If you enter nines in this field, the customer plastic is non- |
| | expiring. |
| NGSYS | Number identifying the system of the gift card |
| | Format: fixed length, four positions |
| | Edits: edited for valid system number on file |
| | This is a required parameter. |
| NGPRIN | Number identifying the principal of the gift card |
| | Format: fixed length, four positions |
| | Edits: edited for valid principal number on file for the |
| | system |
| | This is a required parameter. |
| NGAGT | Number identifying the agent of the gift card |
| | Format: fixed length, four positions |
| | Edits: edited for valid agent number on file for principal |
| | This is a required parameter. |
| MISC3 | Information in miscellaneous field 3 |
| | Format: variable length, seven positions |
| | Edits: the System does not edit this field |
| | This is an optional parameter. |
| | This field is for any data you enter or codes you assign. |
| MISC4 | Information in miscellaneous field 4 |
| | Format: variable length, seven positions |
| | Edits: the System does not edit this field |
| | This is an optional parameter. |
| | This field is for any data you enter or codes you assign. |
| RUSHCODE | Code determining how to mail rush gift cards |
| | Valid codes: Refer to Cardholder New Accounts for valid |
| | Rush Plastics Indicator Codes |
| | This is an optional parameter. |
| MMN | Mother's maiden name (you can use this to send |
| | miscellaneous information) |
| | Format: variable length, eight positions |
| | Edits: the System does not edit this field |
| | This is an optional parameter. |
| PURNAME | Purchaser name - name of the customer (purchaser) (refer |
| | to Cardholder New Accounts for more information about |
| | name entry) |
| | Length: variable length, 26 positions |
| | Edits: edited for alpha values |
| | This is a required parameter. |
| | The number of positions you enter depends on the embossing |
| | format you use. For MasterCard or dual Visa accounts, only 24 |
| | characters may be used for the primary name. The last two |
| | positions, 25 and 26, must be space filled. |
| TRACKID | Tracking identification - client-defined identification code |
| | sent with each transaction request that serves as a reference if |
| | the client later wants to find out the status of that transaction |
| | (whether or not the update to the Host was successful), FDR |
| | stores this code with the status |
| | Length: variable length, 14 positions |
| | This is an optional parameter. |
| RECDOB | Recipient date of birth - date of birth of the gift card recipient |
| | Format: YYYYMMDD |
| | Length: fixed length, eight positions |
| | Edits: edited for numeric values |
| | This is an optional parameter. |
| RECSSN | Recipient Social Security number - Social Security number of |
| | the gift card recipient |
| | Length: Fixed length, 9 positions |
| | Edits: Edited for numeric values |
| | This is an optional parameter. |
| GLEXPDATE | Expiration date used in authorizing the card purchasing the gift |
| | card if it (the purchaser's card) does not belong to the gift card |
| | vendor |
| | Format: DDMM |
| | Length: fixed length, four positions |
| | Edits: edited for numeric characters |
| | This is an optional parameter. However, if you want to include |
| | it as part of the authorization, and the purchaser's card is not |
| | processed by the FDR ® System, include it in this format. If the |
| | purchaser's card is processed by the FDR System, you do not |
| | need to include this parameter since it will be included |
| | automatically. |

Non-Monetary Transactions and Their Components That Can Be Included

| INFOFG | Information flag - flag that indicates whether | |
|---|---|---|
| | NM*177, Miscellaneous Field 10 - Single Position | |
| | transaction, should be sent to change positions 1, 2, | |
| | 3, 4, 5, 6, 7, 8, 9, and/or 10 | |
| | Valid codes: | |
| | Y - Yes | |
| | N - No | |
| | This is a required parameter. | |
| CRDAMT00 | Amount of the gift card (does not include fee or express delivery charge); | |
| | cents must be submitted as zeros; the whole dollar amount populates | |
| | miscellaneous field 10, positions 1, 2, 3, and 4 when INFOFG is Y | |
| | Note: The following information applies only if you | |
| | are using NM*177 to populate miscellaneous field | |
| | 10. See the previous description of CRDAMT00 if | |
| | you are not using NM*177. | |
| | Format: $$$$¢¢ | |
| | Length: variable length, 6 positions | |
| | Edits: edited for numeric values | |
| | This parameter is required in this format if you are sending | |
| | PURSTATE to populate positions 5 and 6. | |
| PURSTATE | Code representing the state in which the customer | |
| | (purchaser) resides - populates miscellaneous field 10, | |
| | positions 5 and 6 when INFOFG is Y | |
| | Valid codes: | |
| | Refer to the Reference Manual for list of state codes. | |
| | This parameter is required only if you are sending HEARD to | |
| | populate position 7. | |
| | It is an optional parameter to send when a Customer Inquiry | |
| | System (CIS) memo for the gift card should be added. Refer | |
| | to NGMEMFG for more information. | |
| HEARD | Client-defined code representing how the gift card | |
| | purchaser heard about the gift card promotion - populates | |
| | miscellaneous field 10, position 7 when INFOFG is Y | |
| | Format: fixed length, one position | |
| | Edits: edited for alpha and numeric values | |
| | This parameter is required only if you are also sending | |
| | CARDTYPE. To populate position 8 | |
| CARDTYPE | Card type - code representing the type of card used to | |
| | purchase the gift card, populates miscellaneous field 10, | |
| | position 8 when INFOFG is Y | |
| | Valid codes: | |
| | 1 - Credit | |
| | 2 - Debit | |
| | 3 - Card that does not belong to your institution | |
| | This parameter is required only if you are sending CAMPTR | |
| | to populate miscellaneous field 10, positions 9 and 10. | |
| CAMPTR | Campaign Tracking Code - client-defined code representing | |
| | the type of campaign, populates miscellaneous field 10, | |
| | positions 9 and 10 when INFOFG is Y | |
| | Format: fixed length, two positions | |
| | Edits: edited for alpha and numeric values | |
| | This is an optional parameter. | |
| ONLINEFG | Online statement flag - flag that indicates whether | |
| | or not NM*721, Cardholder Form Type, Cardholder | |
| | Format Number, Cardholder Disclosure ID | |
| | transaction, should be sent | |
| | Valid codes: | |
| | Y - Yes | |
| | N - No | |
| | This is a required parameter. | |
| STFORM | Statement form - FDR-assigned code identifying the | |
| | cardholder form type; valid code: | |
| | MGD | |
| | This parameter is required only if ONLINEFG is Y. | |
| FORMAT | Statement format - FDR-assigned code identifying the | |
| | cardholder format number; valid code: | |
| | 021 | |
| | This parameter is required only if ONLINEFG is Y. | |
| DISCL | Statement disclosure - FDR-assigned code identifying the | |
| | cardholder disclosure ID; valid code: | |
| | AB | |
| | This parameter is required only if ONLINEFG is Y. | |
| PRODFG | Product flag - indicates whether or not NM*203, Product | |
| | Type transaction, should be sent; required parameter; valid | |
| | codes: | |
| | Y - Yes | |
| | N - No | |
| PRODTYPE | Product type code; valid code: | |
| | 345 | |
| | This parameter is required only if PRODFG is Y. | |
| FIN4FG | Financial Report 4 flag - indicates whether or not NM*214, | |
| | Financial Report 4, should be sent; required parameter; | |
| | valid codes: | |
| | Y - Yes | |
| | N - No | |
| FIN4 | Financial Report 4 - populates the Report4 field; valid code: | |
| | GCO1 | |
| | This parameter is required only if FIN4FG is Y. | |
| LOGOFG | Logo flag - indicates whether or not NM*90, Tape-Entered | |
| | Customer Attributes, should be sent, which in this case | |
| | places a logo with the dollar amount of the gift card on the | |
| | plastic; required parameter; valid codes: | |
| | Y - Yes | |
| | N - No | |
| LOGOCD | Logo code - code indicating which logo for the gift card | |
| | dollar amount should appear on the plastic, matches the | |
| | CRDAMT00 in the table below; valid codes: | |
| | LOGOCD | CRDAMT00 |
| | 00050 | 2500 |
| | 00051 | 5000 |
| | 00052 | 7500 |
| | 00053 | 10000 |
| | 00054 | 15000 |
| | 00055 | 20000 |
| | 00056 | 25000 |
| | 00057 | 30000 |
| | 00058 | 50000 |
| | 00059 | 100000 |
| | 00060 | all other amounts |

| | |
|---|---|
| | This parameter is required only if LOGOFG is Y. |
| NGMEMFG | Memo flag - indicates whether a Customer Inquiry System |
| | (CIS) memo for the gift card should be added; required |
| | parameter; valid codes: |
| | Y - Yes |
| | N - No |
| | The following parameters may be sent with this transaction: |
| | PURNAME, GTCDHSTMEM, PURADDR, PURSSN, PURDOB, |
| | PURCITY, PURSTATE |
| | NOTE: Refer to INFOFG (NM*177) for a description of |
| | PURSTATE. |
| GTCDHSTMEM | Memo status indicator - indicates whether the CIS memo for |
| | the gift card should have a priority or permanent status; |
| | valid codes: |
| | ! - Priority memo that is displayed before all other memos |
| | * - Permanent memo |
| | Send a blank space to indicate a normal memo. |
| | This is an optional parameter. |
| PURADDR | Purchaser address - text of the customer's |
| | (purchaser's) address, which is added to the CIS |
| | memo for the gift card |
| | Length: variable length |
| | Edits: The System does not edit this parameter |
| | This parameter is required only if NGMEMFG is Y. |
| PURSSN | Purchaser Social Security number, which is added to the CIS |
| | memo for the gift card |
| | Length: fixed length, nine positions |
| | Edits: edited for numeric values |
| | This is an optional parameter. |
| PURDOB | Purchaser date of birth, which is added to the CIS memo for |
| | the gift card |
| | Format: YYYYMMDD |
| | Length: fixed length, eight positions |
| | Edits: edited for numeric values |
| | This is an optional parameter. |
| PURCITY | Purchaser city, which is added to the CIS memo for the gift |
| | card |
| | Length: variable length, eighteen positions |
| | Edits: The System does not edit this parameter. |
| | This is an optional parameter. |
| SHPADRFG | Shipping address flag - indicates whether or not NM*113, |
| | Miscellaneous Field 3 - Single Position transaction, should be |
| | sent to change position 1; required parameter; valid codes: |
| | Y - Yes |
| | N - No |
| SHPADR | Shipping address code - populates miscellaneous field 3, |
| | position 1; valid codes: |
| | 0 - purchaser |
| | 1 - recipient |
| | 2 - alternate |
| | This parameter is required only if SHPADRFG is Y. |
| CRSREFFG | Cross reference flag - indicates whether NM*103, Additional |
| | Cross-Reference Number transaction, should be sent; |
| | required parameter; valid codes: |
| | Y - Yes |
| | N - No |
| UPC8FG | Indicates whether NM*216, Client Controls transaction, |
| | should be sent to change the data for client control 8 to the |
| | product identifier code; required parameter; valid codes: |
| | Y - Yes |
| | N - No |
| UPCCD8 | Data for the change to client control 8; valid code: |
| | 511 |
| | This parameter is required only if UPC8FG is Y |
| UPC2FG | Indicates whether or not NM*216, Client Controls |
| | transaction, should be sent to change the data for client |
| | control 2 to a client-defined relationship code; required |
| | parameter; valid codes: |
| | Y - Yes |
| | N - No |
| UPCCD2 | Data for the change to client control 2; valid codes: |
| | L - Client defined |
| | K - Client defined |
| | J - Client defined |
| | I - Client defined |
| | H - Client defined |
| | G - Client defined |
| | F - Client defined |
| | E - Client defined |
| | D - Client defined |
| | C - Client defined |
| | G - Client defined |
| | A - Client defined |
| | This parameter is required only if UPC8FG is Y. |
| UPC3FG | Indicates whether or not NM*216, Client Controls |
| | transaction, should be sent to change the data for client |
| | control 3 to a code that drives the state pricing and |
| | expirations; required parameter; valid codes: |
| | Y - Yes |
| | N - No |
| UPCCD3 | Data for the change to client control 3; valid codes: |
| | A - CA is the state where the customer (purchaser) resides. |
| | Account drives to CA Pricing Strategy via ALP |
| | B - HI is the state where either the customer (purchaser) or |
| | gift card recipient resides. FDR passes the NG transaction to |
| | change the plastic to a 2-year expiration |
| | C - MA is the state where either the customer (purchaser) or |
| | gift card recipient resides. |
| | D - The customer (purchaser) is an employee of the client. |
| | E - No maintenance fee is charged |
| | This parameter is required only if UPC3FG is Y. |
| RSTATEFG | Recipient state flag - indicates whether NM*148, |
| | Miscellaneous Field 7 - Single Position transaction, should be |
| | sent to record the state of the gift card recipient's address |
| | in positions 1 and 2; valid codes: |
| | Y - Yes |
| | N - No |
| | This is a required parameter. |
| STCD | Code representing the state in the gift card recipient's |
| | mailing address - populates miscellaneous field 7, positions |
| | 1 and 2; valid codes: |
| | Refer to the Reference Manual for List of state codes. |
| | This parameter is required only if RSTATEFG is Y. |
| PAPOFFFG | Paper off flag - indicates whether NM*51, Statement Hold |
| | Code transaction, should be sent; valid codes: |
| | Y - Yes |
| | N - No |
| | This is a required parameter. |

If the NG transaction message is successful and the gift card 104 is created from a purchaser account that is associated with the interface site 116 that offered the gift card, a XML datastructure like the below is returned:

```
<?xml version=“1.0” ?>
-<COMMIT>
  <INFO version=“1.2”>First Data Evolve.XML Transactions.</INFO>
  <ACCTID>4326836103801359</ACCTID>
  <WORKFLOW>GTCD</WORKFLOW>
  <GTCDACCT>4170040008000244</GTCDACCT>
  <GTCDPATH>NORMAL2</GTCDPATH>
  <PURADJS>3</PURADJS>
  <SUCCESS>Y</SUCCESS>
  </COMMIT>
```

If the transaction is successful and the gift card 104 is created from a purchaser account that is not associated with the interface site 116, a XML datastructure like the below is returned:

```
<?xml version=“1.0” ?>
<COMMIT>
  <INFO version=“1.2”>First Data Evolve.XML Transactions.</INFO>
  <ACCTID>4782006014141355</ACCTID>
  <WORKFLOW>GTCD</WORKFLOW>
  <GTCDACCT>4170040006005419</GTCDACCT>
  <GTCDPATH>NORMOUT</GTCDPATH>
  <SUCCESS>Y</SUCCESS>
  </COMMIT>
```

A number of variations and modifications of the invention can also be used. For example, the products described in U.S. patent application Ser. No. 10/405,043, U.S. Provisional Patent Application Ser. No. 60/515,918, U.S. patent application Ser. No. 10/675,929, U.S. patent application Ser. No. 10/694,925, U.S. patent application Ser. No. 10/694,924, U.S. patent application Ser. No. 10/079,927, U.S. patent application Ser. No. 10/421,604, U.S. Provisional Patent Application No. __/______ (temporarily referenced by Attorney Docket No. 020375-043000US), U.S. Provisional Patent Application No. __/______ (temporarily referenced by Attorney Docket No. 020375-044500US), and U.S. Provisional Patent Application No. __/______ (temporarily referenced by Attorney Docket No. 020375-018810US), which were all previously incorporated by reference, could use the apparatus and methods described in this application. These products would use the open loop stored value functionality, while supplying additional functionality for alternative or complementary use. In another example, multiple cards could be activated as described in U.S. patent application Ser. No. 10/696,014, which was previously incorporated by reference.

While the principles of the invention have been described above in connection with specific apparatuses and methods, it is to be clearly understood that this description is made only by way of example and not as limitation on the scope of the invention.

1. A payment system for open loop stored benefit products, the payment system comprising:
a web-accessible platform available to a payor for purchase of a stored benefit account for use by a payee, wherein:
the web-accessible platform communicates with a first application interface,
the stored benefit account is backed by an account issuer, and
the stored benefit account is accepted by a network of unrelated merchants who accept payments from the account issuer;
a web interface that allows the payor or the payee to interact with the web-accessible platform;
a credit processing system communicating with a second application interface; and
a translation system that translates between the first application interface and the second application interface.

2. The payment system for open loop stored benefit products as recited in claim 1, wherein the payor pays for the stored benefit account.

3. The payment system for open loop stored benefit products as recited in claim 1, wherein the credit processing system includes a main frame running a main frame language.

4. The payment system for open loop stored benefit products as recited in claim 1, wherein:
a card is issued to the payee, and
the card facilitates payments from the stored benefit account.

5. The payment system for open loop stored benefit products as recited in claim 1, wherein the first application interface uses XML.

6. The payment system for open loop stored benefit products as recited in claim 1, wherein the stored benefit account corresponds to a benefit table for use by the network.

7. The payment system for open loop stored benefit products as recited in claim 1, wherein the stored benefit account corresponds to an amount of money usable with the network.

8. The payment system for open loop stored benefit products as recited in claim 1, wherein the translation system is integral with one of the credit processing system and the web-accessible platform.

9. The payment system for open loop stored benefit products as recited in claim 1, wherein the web interface is hosted remote from the web-accessible platform.

10. The payment system for open loop stored benefit products as recited in claim 1, wherein the web-accessible platform does not store information that would allow a hacker, who compromised information stored on the web-accessible platform, to use the stored benefit account.

11. The payment system for open loop stored benefit products as recited in claim 1, wherein the account issuer is one of a plurality of account issuers that are part of a branded association that accept each others stored benefit account transactions.

12. The payment system for open loop stored benefit products as recited in claim 1, wherein the open loop stored benefit products are based upon a credit card platform of the credit processing system.

13. A payment system for open loop stored benefit products, the payment system comprising:
a web-accessible platform available to a payor for purchase of a stored benefit account for use by a payee, wherein:
the web-accessible platform communicates with a first application interface,
the stored benefit account is backed by an account issuer, and
the stored benefit account is accepted by a network of unrelated merchants who accept payments from the account issuer;
a web interface that allows the payor or the payee to interact with the web-accessible platform;
a credit processing system communicating with a second application interface; and
a translation system that translates between the first application interface and the second application interface, wherein the account issuer is one of a plurality of account issuers that are part of a branded association that accept each others stored benefit account transactions.

14. The payment system for open loop stored benefit products as recited in claim 13, wherein the payor pays for the stored benefit account.

15. The payment system for open loop stored benefit products as recited in claim 13, wherein the credit processing system includes a main frame running a main frame language.

16. The payment system for open loop stored benefit products as recited in claim 13, wherein:
a card is issued to the payee, and
the card facilitates payments from the stored benefit account.

17. The payment system for open loop stored benefit products as recited in claim 13, wherein the first application interface uses XML.

18. The payment system for open loop stored benefit products as recited in claim 13, wherein the stored benefit account corresponds to a benefit table for use by the network.

19. The payment system for open loop stored benefit products as recited in claim 13, wherein the stored benefit account corresponds to an amount of money usable with the network.

20. The payment system for open loop stored benefit products as recited in claim 13, wherein the translation system is integral with one of the credit processing system and the web-accessible platform.

21. The payment system for open loop stored benefit products as recited in claim 13, wherein the web interface is hosted remote from the web-accessible platform.

22. The payment system for open loop stored benefit products as recited in claim 13, wherein the web-accessible platform does not store information that would allow a hacker, who compromised information stored on the web-accessible platform, to use the stored benefit account.

23. The payment system for open loop stored benefit products as recited in claim 13, wherein the open loop stored benefit products are based upon a credit card platform of the credit processing system.

24. A payment system for open loop stored benefit products, the payment system comprising:
a web-accessible platform available to a payor for purchase of a stored benefit account for use by a payee, wherein:
the web-accessible platform does not store information that would allow a hacker, who compromised information stored on the web-accessible platform, to use the stored benefit account,
the web-accessible platform communicates with a first application interface,
the payor pays for the stored benefit account,
the stored benefit account corresponds to an amount of money usable with a network,
the stored benefit account is backed by an account issuer, and
the stored benefit account is accepted by the network of unrelated merchants who accept payments from the account issuer;
a web interface that allows the payor or the payee to interact with the web-accessible platform;
a credit processing system communicating with a second application interface; and
a translation system that translates between the first application interface and the second application interface, wherein:
the open loop stored benefit products are based upon a credit card platform of the credit processing system,
the account issuer is one of a plurality of account issuers that are part of a branded association that accept each others stored benefit account transactions,
a card is issued to the payee, and
the card facilitates payments from the stored benefit account.
